(19) United States
(12) Patent Application Publication
(10) Pub. No.: US 2005/0042134 A1
(43) Pub. Date: Feb. 24, 2005

(54) Sensor

(75) Inventors: James Thomson, Dundee (GB); Wolfram Meier-Augenstein, Dundee (GB)

Correspondence Address: DRINKER BIDDLE & REATH, ONE LOGAN SQUARE, 18TH AND CHERRY STREETS, PHILADELPHIA, PA, 19103-6996, US

(73) Assignee: The Queen's University of Belfast, Belfast (GB)

(21) Appl. No.: 10/488,012

(22) PCT Filed: Aug. 23, 2002
(86) PCT No.: PCT/GB02/03888

(30) Foreign Application Priority Data
Aug. 30, 2001 (GB) 0120962.6

(51) Int. Cl. G01N 21/76

(52) U.S. Cl. 422/52

(57) ABSTRACT

The present invention relates to a sensor device for detecting CO₂ and/or NOₓ, the sensor device comprising a redox material coated on a conducting substrate, the resistance of which changes in the presence of CO₂ and/or NOₓ. The conducting substrate may also be heated to enhance functioning of the sensor device.

The present invention relates to a sensor device and a method of fabrication thereof suitable for use in detecting CO₂ and NO₂ gases.

In recent years there has been an increasing awareness in both the commercial and public sectors of the impact and importance of various gases, especially carbon dioxide, CO₂, on the environment. Terms such as the “green-house effect” and “global warming” have become everyday issues and there is a perceived need to both detect and limit the production of gases such as CO₂ which are considered to contribute to the green-house effect and global warming.

U.S. Pat. No. 5,958,340 (MEYER et al) provides a discussion on a variety of types of CO₂ sensors amongst which are included sensors which rely upon measuring changes in capacitance of a sensor material as it interacts with CO₂. One problem with this type of sensor is that the sensor materials are generally in the forms of tablets which are prone to breakage. Additionally, sensors of this type also require external heating to temperatures of approximately 475° C. The invention of U.S. Pat. No. 5,958,340 is based upon thick film technology and discloses a CO₂ sensitive material coated on for example Al₂O₃ ceramics. One drawback of using an Al₂O₃ ceramic is that it is non-flexible and as a result may be broken relatively easily.

GB 2,149,123A (United Kingdom Atomic Energy Authority) discloses a CO₂ sensor which can only be heated by an external heating apparatus. Additionally, devices of this type generally have high power consumptions.

It is an object of the present invention to obviate or minimise one or more of the disadvantages of the prior art.

The present invention provides a sensor device suitable for detecting one or more of CO₂ and NOₓ comprising:
a conducting substrate having at least one layer of a redox material coated thereon, wherein the redox material comprises from about 5 to 95 mol % zirconia and the balance comprising at least one lanthanide oxide, wherein a resistance value of the redox material changes in the presence of one or more of CO₂ and NOₓ.

A resistance measuring device may be electrically connected to the redox material being formed and arranged to measure, in use, the change in resistance of the redox material in the presence one or more of CO₂ and NOₓ.

The conducting substrate may be in the form of for example a wire, a hollow monolith or a plate formed from a material such as for example a metal, a metal alloy such as stainless steel FeCrAlloy or a solid electrolyte material. If it is desirable that the material forming the conducting substrate in the form of a wire, for example, may be formed into various shapes or configurations such as by twisting, winding, knitting or forming into a mesh.

FeCrAlloy is the TRADENAME of material formed from Fe, Cr and Al having the following composition: Fe_{72.8}/Cr₂₂/Al₅/Y_{0.1}/Zr_{0.1}.

The redox material may typically comprise from about 30 to 85 molt, such as from about 40 to 75 molt, preferably about 50 to 65 molt zirconia with the balance comprising at least one lanthanide oxides. The incorporation of zirconia into the redox material provides a measure of thermal stability to the redox material in use thereof as zirconia has a relatively high thermal hysterisis at upper continuous use temperatures of 2200° C.

Additionally, it has been found that zirconia has good adhesion to said a substrate.

The substrate preferably incorporates a lanthanide oxide or oxides with a stable porous structure. For example the redox material may comprise from 5 to 95 molt, or from 15 to 70 molt, or from 25 to 60 molt or from 35 to 50 molt of said one or more lanthanide oxides. The one or more lanthanide oxide advantageously comprises cerium oxide.

Further lanthanide oxides may be added to the ceria, yttria and gadolinia such as for example oxides of Pr and Nd.

The redox material may further comprise one or more of other elements and/or oxides thereof such as Ni, Rh, Ru, Co, Fe, W and Zn.

The resistance measuring device may be of any suitable construction or type such as for example a simple Wheatstone Bridge or a direct resistance monitoring means.

The sensor of the present invention may be used to detect CO₂ and/or NOₓ gas concentrations of from 0.01 volt to 100 vol %, preferably from 0.1 vol % to 50 vol %, more preferably from 0.1 vol % to 25 vol %, and particularly from 0.5 to 10 vol %.

It will be appreciated that in order to achieve higher sensitivities (e.g. 1000 ppm to 0.1 vol %) to CO₂ and/or NOₓ it may be necessary to reduce the thickness of the redox material on the substrate material relative to that required for lower sensitivities (e.g. 0.1 vol % to 10 vol %).

Without being bound by theory it is thought that the redox material forms a decomposable carbonate material in the presence of CO₂, and a decomposable nitrate material in the presence of NOₓ. The carbonate/nitrate material has a different (e.g. second) resistance value from that of the starting or unreacted redox material which has a first resistance value. The difference between the first and second resistance values being measurable by the resistance measuring device and thereby, providing a sensor for the presence of CO₂ and/or NOₓ gases when they are passed over the redox material of the sensor of the present invention.

Where NO is present it is also thought that the NO is oxidised to NO₂ on the redox material by atmospheric oxygen included with a sample gas containing NO.

The sensor device, or at least a sensing portion thereof comprising said conducting substrate with at least one layer of said redox material thereof, may be heated to a temperature of from 50° C. to 750° C. The sensor device or said sensing portion may be heated by providing an oven or other similar heating device which is arranged so as to enclose said device or sensing portion. The oven is desirably provided with one or more of each of a gas inlet and outlet which are formed and arranged to allow a gas to flow therethrough. The arrangement of the gas inlet(s)/outlet(s) may be such that a gas passing, in use of the sensor device of the present invention, is directed to flow directly over said sensing portion.

Additionally, or alternatively, said substrate material where suitable, e.g. when formed from FeCrAlloy, may be used as a source of heat to the sensor device as such materials can be used as heating elements by passing an electric current therethrough.

Further preferred features and advantages of the present invention will now be described with particular reference to the drawing, wherein:

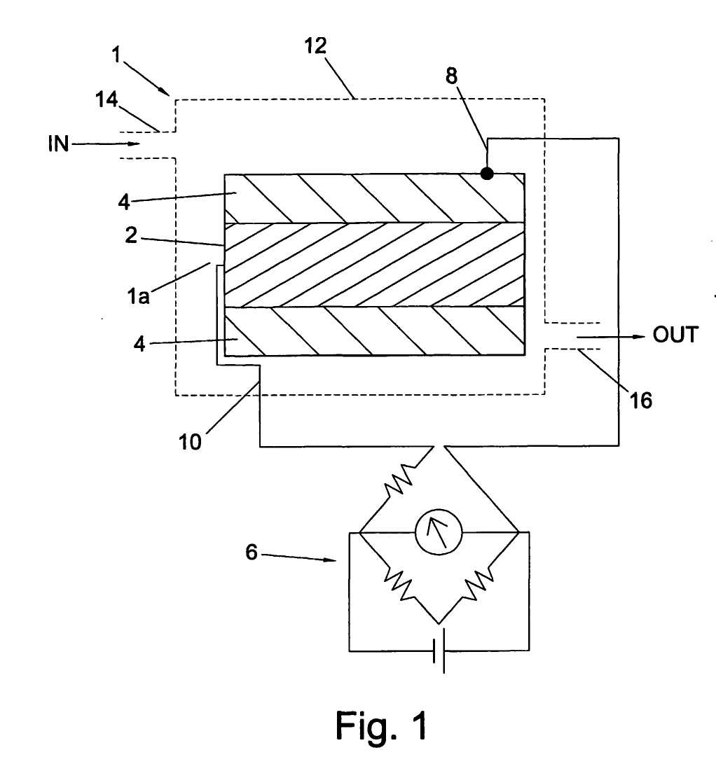

FIG. 1 shows a schematic diagram of a sensor device according to one aspect of the present invention;

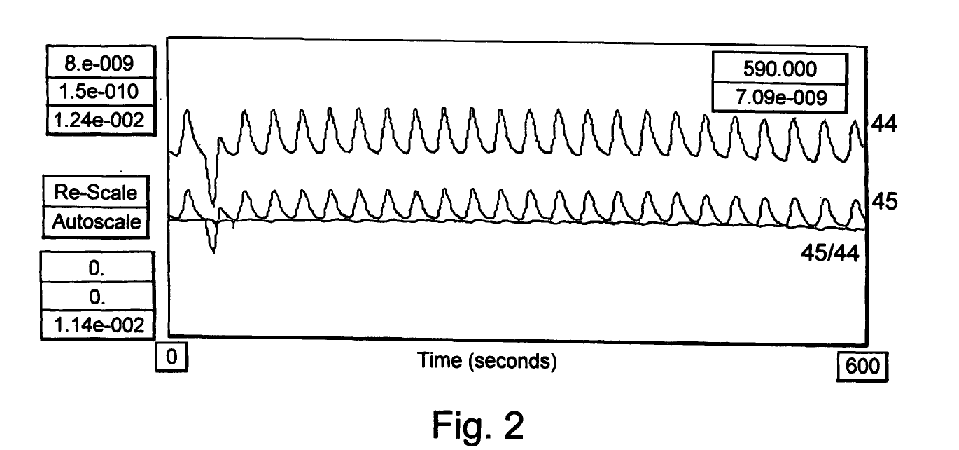

FIG. 2 shows a graph of an isotope ratio mass spectrograph of an IRMS trace; and

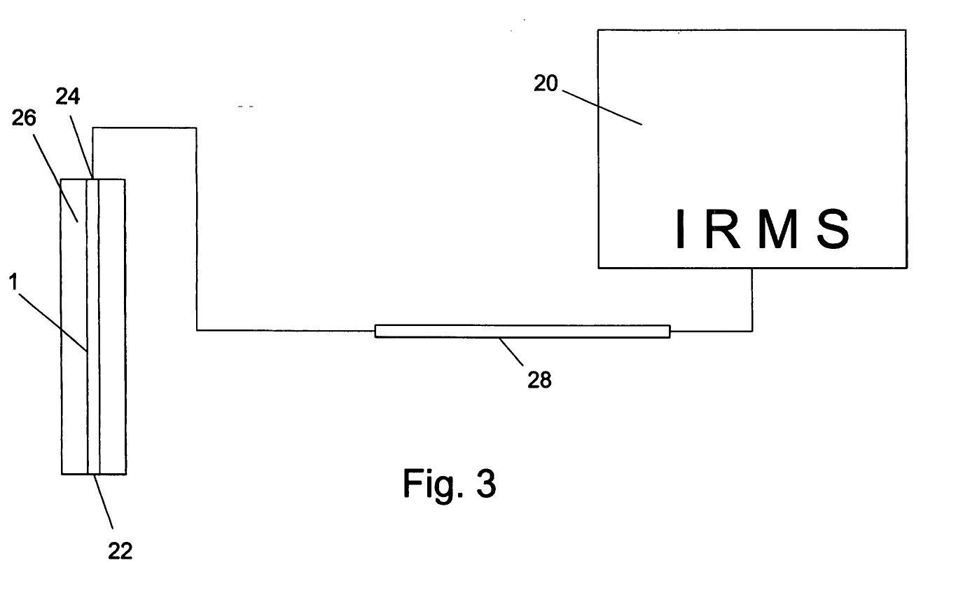

FIG. 3 shows a schematic diagram of the sensor of FIG. 1 operatively connected to an IRMS.

A CO₂/NO₂ sensor device as generally indicated by reference numeral 1 is shown in FIG. 1.

The sensor 1 has a sensing portion 1a comprising a conducting substrate 2 (shown in section) formed from FeCrAlloy wire. The substrate 2 is coated with a redox material 4 formed from 68 molt zirconia and, 32 mol % ceria. A resistance meter 6 (Wheatstone bridge shown) has a first electrical wire 8 extending therefrom and is in electrical contact with the redox material 4, and a second electrical wire 10 in contact with the conducting substrate 2. The sensing portion 1a is disposed within an oven 12 (dashed line) which is formed and arranged for heating the sensing portion 1a to temperatures of from 50 to 750° C.

The 32 molt zirconia/ceria redox material was prepared using:
(1) a sol-gel technique wherein to a known volume of 50% HNO₃ sufficient Zr(CO₃)₂ and Ce(NO₃)_{30.6}H₂O was added with stirring for 2 hours at 80° C. to produce a sol containing 32 molt Ce(NO₃)₃ and 68 molt ZrO(NO₃)₂. The sol was painted onto a FeCrAlloy wire preheated to 600° C. for 2 hours. The coated FeCrAlloy wire was then baked in air at 359° C. for 2 hours;
(2) alternatively, the 32 molt ceria/zirconia redox material was produced from an ethanol solution comprising the acetates of Zr and Ce in the above-noted molar ratios. A FeCrAlloy wire was then coated by painting the wire onto the ceria/zirconia sol. The FeCrAlloy wire was precalcined at 600C for 2 hours in air.

The oven 12 has a gas inlet 14 at one end thereof, and a gas outlet 16 at another end. The sensing portion 1a is disposed between the inlet and outlet 12, 14 so as to allow a sample gas passing through the oven 12 passes over the sensing portion 1a.

In use, a sample gas containing CO₂ and/or NOₓ is passed through the inlet 14 and over the sensing portion 1a. The CO₂/NOₓ interacts with the redox material 4 to form decomposable carbonates and/or nitrates on the redox material surface. It is thought that the change in composition of the redox material 4 results in a change in resistance measured between the first and second wires by the resistance meter 6. The sensing portion 1a is maintained at approximately 300° C. by the oven 12.

FIG. 2 is a graph obtained from an isotope ratio mass spectrograph of 10 vol % CO₂ in He carrier gas after passing through the sensor 1. The sensor temperature was kept at 370° C.

TABLE 1

| PARAMETER | ACTUAL | SET | UNITS |
|---|---|---|---|
| HT | 2523.1 | 2508.0 | V |
| Trap | 601.0 | 599.0 | μA |
| Electron Energy | −70.0 | −69.0 | EV |
| Ion Repeller | −3.3 | −3.4 | V |
| Z Plates | 0.0 | 0.0 | V |
| Beam Focus | 82.4 | 81.4 | % |
| Emission | 17.0 | N/A | μA |

Header Amp Zero Offsets: Beam1 62710 Beam2 1116 Beam3 1268.

The upper trace shows the change in detector current with time as CO₂ is passed through the IRMS. The maxima of the peaks correspond to increased concentrations of CO₂ passing through the IRMS whereas the minima correspond to relatively decreased concentrations of CO₂. From the upper trace of FIG. 2 it is can be seen that the concentration of CO₂ eluted from the sensor 1 varies more or less sinusoidally. Without being bound by theory it is proposed that the variation in concentration of CO₂ arises from the cyclical restructuring of at least the surface of the redox material forming part of the sensor 1 such that the chemical species alternate between predominantly oxide species and carbonate species. Where the surface of the redox material comprises predominantly carbonate species then the concentration of CO₂ in the eluted gas stream is relatively low and where the surface of the redox material comprises predominantly oxide species then the CO₂ concentration is relatively high. The changes in chemical composition of at least the surface of the redox material results in a change in the resistivity of the redox material and therefore of the sensor portion 1a of the sensor 1. The change in resistivity of the sensor portion 1a may be detected directly by using a resistance meter (not shown).

The lower trace in FIG. 2 shows the isotopic ratio between ¹²CO₂ and ¹³CO₂ species in the eluted CO₂ from the sensor 1.

FIG. 3 shows a schematic diagram of the sensor 1 in fluid communication an IRMS 20. Carbon dioxide gas is passed through a gas inlet 22 to an outlet 24 of the sensor 1 which is enclosed within a furnace 26 which is maintained at a temperature of from 300 to 400° C. A water-trap 28 is positioned in-line between the sensor 1 and the IRMS 20. In use CO₂ is passed through the inlet 22 through the sensor 1 to exit via the outlet 24 into the water-trap 28 leading to the IRMS 20 which produces the upper and lower traces of FIG. 2 and as described above.

Possible uses for the sensor of the present invention include for example detecting. CO₂ and/or NOₓ concentration levels in vehicle cabins such as trucks which can be exposed to relatively high concentrations of these potentially harmful gases on a regular basis. Additionally the sensor may be used to detect CO₂ and/or NOₓ concentration levels in vehicle exhaust emissions or for monitoring of industrial waste gases. The foregoing applications are only examples of possible uses however it will be appreciated that the list of possible applications for CO₂ and/or NOₓ sensors is extensive and no attempt is made here to list the scope of these applications which will be apparent to a skilled person.

1. A sensor device suitable for detecting one or more of CO₂ and NOₓ comprising:
a conducting substrate having at least one layer of a redox material coated thereon, wherein the redox material comprises from about 5 to 95% zirconia and the balance comprising at least one lanthanide oxide, wherein a resistance value of the redox material changes in the presence of one or more of CO₂ and NOₓ.

2. The sensor device according to claim 1 further comprising a resistance measuring device electrically connected to the redox material, being formed and arranged to measure, in use, the change in resistance of the redox material in the presence of one or more of CO₂ and NOₓ.

3. The sensor device according to claim 1 wherein the conducting substrate is in the form of a wire, a hollow monolith, or a plate.

4. The sensor device according to claim 3 wherein the wire, hollow monolith or plate comprises a metal, a metal alloy or a solid electrolyte material.

5. The sensor device according to claim 1 wherein the redox material comprises from about 30 to 85 mol % zirconia with the balance comprising at least one lanthanide oxide.

6. The sensor device according to claim 1 wherein the one or more lanthanide oxide comprises cerium oxide.

7. The sensor device according to claim 1 in the form of a Wheatstone Bridge or a direct resistance monitoring means.

8. The sensor device according to claim 1 wherein in use said conducting substrate is heated to a temperature of from about 50° C. to 750° C.

9. The sensor device according to claim 8 wherein heating of the conducting device is by way of incident or direct heating.
